(19) United States
(12) Patent Application Publication
(10) Pub. No.: US 2010/0198732 A1
(43) Pub. Date: Aug. 5, 2010

(54) COMMUNICATION SYSTEM, A MEDIA PLAYER USED IN THE SYSTEM AND A METHOD THEREOF

(75) Inventors: Wong Hoo Sim, Singapore (SG); Peng Kiat Phneah, Singapore (SG); Seh Eing Lim, Singapore (SG); Chin Wei Vinson Chua, Singapore (SG); Cheng Kiang Ng, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd., Singapore (SG)

(21) Appl. No.: 12/516,346

(22) PCT Filed: Nov. 27, 2007
(86) PCT No.: PCT/SG2007/000408

§ 371 Date: May 26, 2009

Related U.S. Application Data
(60) Provisional application No. 60/861,188, filed on Nov. 27, 2006.

(51) Int. Cl. G06Q 30/00; H04L 9/00; G06Q 99/00; G06Q 50/00

(52) U.S. Cl. 705/75; 705/14.51; 705/14.53; 705/14.61

(57) ABSTRACT

There is provided a communication system including a plurality of content receiver cum transmitter devices connected to a network, each device being for receiving content, selectively storing content and for selectively re-transmitting content. The system may include at least one server for storage of advertisements and transmission of advertisements either directly to the plurality of content receiver cum transmitter devices, or the transmission of advertisements being directed by at least one chaincast manager, the at least one server for storage of advertisements and transmission of advertisements being either online or offline. There may also be at least one content server connected to the network for storage of content and transmission of content either directly to the plurality of content receiver cum transmitter devices, or the transmission of content being directed by at least one chaincast manager. The at least one chaincast manager connected to the network may preferably be for registering the plurality of content receiver cum transmitter devices, and for scheduling content and advertisement transfers amongst the plurality of content receiver cum ransmitter devices. It is advantageous that the system enables simultaneous recording and transmission of content by each content receiver cum transmitter device with minimal lag time. A corresponding method of the aforementioned system and an embodiment of the content receiver cum transmitter device are also described.

### FIELD OF INVENTION

The present invention relates to the field of media information communication. More specifically, the present invention includes a method, a system and a media player used in the system to transmit content within a network using a chaincast communication system.

### REFERENCED APPLICATION

Reference in the specification is made to PCT/US2001/006786 (WO 2001/065767), filed by Chaincast Inc on 28 Feb. 2001. Chaincast Inc has been acquired by, the applicant/assignee of the present application, Creative Technology Ltd.

### BACKGROUND

There is an increasing number of people who have embraced the habit of regularly expressing themselves over the internet by having their own blogs or online diaries. They express their thoughts for any possible issue in words, sound clips or videos for consumption by the public, and some of these bloggers have attracted their own band of followers who either have the same mindset/interest or are simply fans of the bloggers per se.

These bloggers act like a hub where like-minded people or fans gather and peruse content which interest them and also enable the sharing of thoughts/opinions on subjects close to their heart. Due to the presence of such bloggers, an online community may form which comprises people with similar mindsets/interests or fans who hang on the words of the bloggers. Having access to such a community may be a golden opportunity for commercial entities seeking groups of a particular mindset/interest. There is a degree of certainty for the commercial entity that interest would be generated in a particular product/service if that product/service is deemed to appeal to a particular mindset/interest.

However, there is currently no system which allows for a blogger to make a live video broadcast to an audience equipped with individual handheld devices that are also able to receive advertisements which the audience may express an interest in. The present invention presents such a solution.

### SUMMARY

There is provided a communication system including a plurality of content receiver cum transmitter devices connected to a network, each device being for receiving content, for selectively storing content, and for selectively retransmitting content. The system may include at least one server for storage of advertisements and transmission of advertisements either directly to the plurality of content receiver cum transmitter devices, or the transmission of advertisements being directed by at least one chaincast manager, the at least one server for storage of advertisements and transmission of advertisements being either online or offline. There may also be at least one content server connected to the network for storage of content and transmission of content either directly to the plurality of content receiver cum transmitter devices, or the transmission of content being directed by at least one chaincast manager. The at least one chaincast manager connected to the network may preferably be for registering the plurality of content receiver cum transmitter devices, and for scheduling content and advertisement transfers amongst the plurality of content receiver cum transmitter devices. It is advantageous that the system enables simultaneous recording and transmission of content by each content receiver cum transmitter device with minimal lag time. It is advantageous that the plurality of content receiver cum transmitter devices may enable real time communication between users.

The system may include a membership module for access to the chaincast manager. The membership module may include storage of user parameters, the user parameters selected from the group consisting of: profile score, user interests, a right to broadcast content using the system, a right to receive content using the system, a right to participate in commercial activities using the system, and channel favourites of the user. Access to the membership module may be either free or paid. Preferably, the aforementioned commercial activities are selected from the group consisting of: online auctions, online donations and online shopping.

It is preferable that the advertisements are selected from either public service announcements or commercially motivated announcements. The m advertisements may be cached in the plurality of content receiver cum transmitter devices and transmitted at a later instance. It is advantageous that the scheduling of content and advertisement transfers by the chaincast manager is based on parameters selected from the group consisting of: profile score, broadcast requests sent from the plurality of content receiver cum transmitter devices, the user interests and the channel favourites of the user. The content stored in the content server may be transmitted either per a predetermined schedule or on an “on demand” basis.

The at least one server connected to the network for storage of advertisements is accessible by advertisers who upload their advertisements with a plurality of settings selected from the group consisting of: profile score, interest group, age group target and advertisement ratings. It is advantageous that the advertisers are billed with information selected from either by frequency of views/playback or by subscription. Preferably, the billing information for advertisers are either encrypted or DRM protected.

Preferably, at least one of the content servers includes a voice-to-text conversion function to convert voice-based content into a form which is text searchable. In addition, at least one of the content servers may also include a voice identification function to enable voice-based content to be voice searchable

There is also provided a media player connectable to a network, including: a display module incorporated in the media player to show visual content; a camera module incorporated in the media player to record visual content; an audio module to input and output audio content; at least one memory module to store content in the media player; a wireless receiver cum transmitter module for input and output of content from the media player; and a processor to control the aforementioned modules. It is advantageous that the media player is connectable to at least one chaincast manager connected to the network for registering a plurality of media players, the at least one chaincast manager also for scheduling content and advertisement transfers amongst the plurality of media players. It is advantageous that the media player may be enabled for simultaneous recording and transmission of content with minimal lag time.

The media player may interface with a membership module coupled to the at least one chaincast manager to allow access to the at least one chaincast manager. The membership module may include storage of user parameters such as, for example, profile score, user interests, a right to broadcast content using the system, a right to receive content using the system, a right to participate in commercial activities using the system, and channel favourites of the user. It is preferable that the commercial activities are selected from the group consisting of: online auctions, online donations and online shopping. Scheduling the content and advertisement transfers by the chaincast manager is based on parameters such as, for example. profile score, broadcast requests sent from the plurality of content receiver cum transmitter devices, the user interests and the channel favourites of the user. The advertisements may be cached in the media player and transmitted at a later instance.

The wireless receiver cum transmitter module of the media player may utilise wireless technologies like UWB, Bluetooth, infrared, and any form of radio frequency transmission. The display module may include a screen selected from a panel from the group consisting of: TFT, OLED, LCD and CSTN. The screen may be touch-sensitive.

It is advantageous that the media player may further include a graphical user interface with a virtual “activator”, wherein the “activator” has different activation functions depending on content shown on the screen. The activation functions are for example, bidding, invoking transaction, text transmit and voice transmit. It is advantageous that the media player may enable real time communication between users.

The present application also discloses a method of communicating content over a network. The method includes registering a plurality of content receiver cum transmitter devices with a chaincast manager; transmitting content from the at least one content receiver cum transmitter device connected to a network; selectively storing content in the at least one content receiver cum transmitter device; selectively re-transmitting content from the at least one content receiver cum transmitter device; transmitting advertisements from at least one advertisement server to either directly to a plurality of content receiver cum transmitter devices, or the transmission of advertisements being is directed by at least one chaincast manager; receiving the content and advertisements on at least one content receiver cum transmitter device with the at least one chaincast manager scheduling content and advertisement transfers amongst the plurality of content receiver cum transmitter devices. The method may advantageously enable simultaneous recording and transmission of content by each content receiver cum transmitter device with minimal lag time. It is advantageous that the plurality of content receiver cum transmitter devices may enable real time communication between users.

In the method, registration of the plurality of content receiver cum transmitter devices with a chaincast manager may be done through a membership module. The membership module may include storage of user parameters, the user parameters selected from the group consisting of: profile score, user interests, a right to broadcast content, a right to receive content, a right to participate in commercial activities, and channel favourites of the user. Preferably, the commercial activities are online auctions, online donations or online shopping. The advertisements may be either public service announcements or commercially motivated announcements. The advertisements may be cached in the plurality of content receiver cum transmitter devices and transmitted at a later instance.

It is advantageous that the scheduling of content and advertisement transfers by the chaincast manager is based on parameters selected from for example, profile score, broadcast requests sent from the plurality of content receiver cum transmitter devices, the user interests and the channel favourites of the user.

In the method, it is preferable that the at least one advertisement server is accessible by advertisers who upload their advertisements with a plurality of settings selected from the group consisting of: profile score, interest group, age group target and advertisement ratings. Preferably, the advertisers may be billed with information selected from either by frequency of views/playback or by subscription. It is important that billing information for advertisers may be either encrypted or DRM protected.

### DESCRIPTION OF DRAWINGS

In order that the present invention may be fully understood and readily put into practical effect, there shall now be described by way of non-limitative example only preferred embodiments of the present invention, the description being with reference to the accompanying illustrative drawings.

FIG. 1 shows an overview of a communication system of the present invention.

FIG. 2 shows a schematic diagram of a media player of the present invention.

FIG. 3 shows a flow chart for a method of communication over a network as per the present invention.

FIG. 4 shows a physical representation of the media player of FIG. 2 when in use in a first application.

FIG. 5 shows a physical representation of the media player of FIG. 2 when in use in a second application.

FIG. 6 shows a physical representation of the media player of FIG. 2 when in use in a third application.

FIG. 7 shows a physical representation of the media player of FIG. 2 when in use in a fourth application.

### DESCRIPTION OF PREFERRED EMBODIMENTS

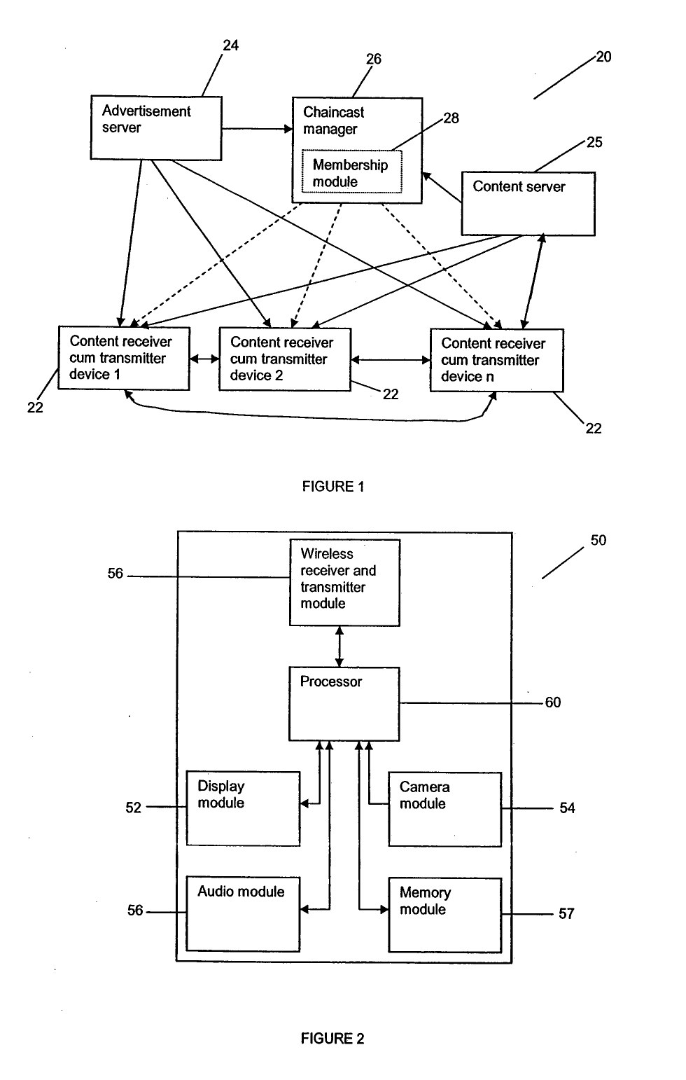

In a preferred embodiment of the present application, there is provided a communication system 20 as shown in FIG. 1. It is necessary for the system 20 to be used with the chaincast network as disclosed in the referenced application. The system 20 may include a plurality of content receiver cum transmitter devices 22 connected to a network. Only three content receiver cum transmitter devices 22 are shown in FIG. 1, but it is conceivable that the number of content receiver cum transmitter devices 22 may be immense. It should be noted that the system 20 would not be functional if there was only a single content receiver cum transmitter device 22. It is preferable that the plurality of content receiver cum transmitter devices 22 are wirelessly connected to the network. The network may be a restricted network or the internet. In accordance with data transfer via chaincast, each device 22 may be able to receive content, able to selectively store content and able to selectively re-transmit content with each other. The system 20 may allow for simultaneous recording and transmission of content by each device 22 with minimal lag time due to the lower bandwidth requirements of chaincasting. The system 20 may be usable across national borders if there are adequate numbers of content receiver cum transmitter devices 22, such that the network used is not the internet and users are able to bypass internet service providers in their respective countries when using the system 20.

Wireless communication between the plurality of content receiver cum transmitter devices 22 may occur without intervention by at least one chaincast manager 26 using wireless technologies such as, for example, UWB, Bluetooth, infrared, and any form of radio frequency transmission. The plurality of content receiver cum transmitter devices 22 would need to be within a transmission range of the wireless technology being utilised for wireless communication to take place.

There may be at least one server 24 connected to the network for storage of advertisements. The advertisement server 24 may also transmit advertisements to the plurality of content receiver cum transmitter devices 22. This is done either via direct transmission to the plurality of content receiver cum transmitter devices 22, or by relying on the at least one chaincast manager 26 to direct the transmission of advertisements to the plurality of content receiver cum transmitter devices 22. The advertisements may be either public service announcements or commercially motivated announcements. The advertisements may be of the interactive type. Advertisers may access the advertisement server 24 to upload their advertisements with a plurality of settings, such as, for example, interest group, age group target, advertisement ratings and so forth. Access to the advertisement server 24 by the advertisers may be made available for a fee. The advertisements may be tagged with related content (and subsequently transmitted together) or may be independent. The advertisements (either from the advertisement server 24 or another content receiver cum transmitter devices 22) may be cached in the plurality of content receiver cum transmitter devices 22 and transmitted at a later instance. In this regard, the advertisement server 24 may not be a mandatory aspect of the communication system 20. Advertisements may be transmitted among the plurality of content receiver cum transmitter devices 22 connected to the system 20 regardless of whether the advertisement server 24 is connected to the communication system 20.

There may also be at least one content server 25 connected to the network for storage of content. The at least one content server 25 may be, for example, a remote storage device, a home based server and so forth. The content server 25 may store content transmitted from each of the plurality of content receiver cum transmitter devices 22. The content server 25 may also transmit content to the plurality of content receiver cum transmitter devices 22. This is done either via direct transmission to the plurality of content receiver cum transmitter devices 22, or by relying on the at least one chaincast manager 26 to direct the transmission of content to the plurality of content receiver cum transmitter devices 22. Control of the transmission of content to and between the plurality of content receiver cum transmitter devices 22 by the chaincast manager 26 is depicted by the dotted-lines arrows in FIG. 1. The content stored in the content server 25 may be arranged in channels or grouped under specific subjects/interests. The content stored in the content server 25 may be transmitted as per a predetermined schedule or on an “on demand” basis. At least one of the content servers 25 may include voice-to-text conversion functionality to convert voice-based content into a form which is text searchable. In addition, at least one of the content servers 25 may include voice identification functionality such that the voice-based content is voice searchable.

The at least one chaincast manager 26 may be connected to the network and the plurality of content receiver cum transmitter devices 22 may be registered with the chaincast manager 26. The chaincast manager 26 may perform tasks such as scheduling content and advertisement transfers amongst the plurality of content receiver cum transmitter devices 22. The chaincast manager 26 may schedule the content and advertisement transfers based on parameters such as, for example, broadcast requests sent from the plurality of content receiver cum transmitter devices 22, user interests and the channel favourites of the user.

The chaincast manager 26 may include a membership module 28 that either allows or blocks access to the chaincast manager 26. The membership module 28 may be part of the chaincast manager 26 or an independent module which interacts with the chaincast manager 26. The membership module 26 may include storage of user parameters such as, for example, user interests, a right to broadcast content using the system 20, a right to receive content using the system 20, a right to participate in commercial activities using the system 20, and channel favourites of the user. The right to broadcast/receive content may be based on a quantity of data scheme, where broadcasting/receiving content beyond a specified quantity may incur additional charges in addition to a basic cost of the data scheme. The fee to obtain access to the membership module 28 may be waived if the user accedes to either carrying advertisements during their broadcasts or viewing advertisements when receiving broadcasts.

Generally, these parameters may be mandatory information required for the membership module 26 to operate in a desired manner. The parameters stored in the membership module 26 for a user enables the user to have a specific profile for use in the system 20. Such a profile determines tasks which the user is able to perform in the system 20 and is also used to identify the user and/or specific content receiver cum transmitter device 22. This is to because each user and/or specific content receiver cum transmitter device 22 may not be identifiable by an IP address as the content receiver cum transmitter device 22 need not be connected to the internet. The profile also enables appropriate content/advertisements in accordance with the user's interests to be sent to the user should the user allow reception of the content/advertisements on their content receiver cum transmitter devices 22. The profile may be quantified into a numerical score using a predetermined scoring system. Users with a profile within a particular scoring range may be grouped together to form a community of users with similar profiles. All content management, marketing efforts, and advertising may be dependent on the profile score.

The commercial activities allowable on the system 20 may include online auctions, online donations and online shopping. Users may be able to use their content receiver cum transmitter devices 22 to bid for items in online auctions or make purchases from online stores/sellers. The commercial activities may be done in real-time in response to the content that the users receive in their content receiver cum transmitter devices 22.

Access to the membership module 28 may be allowed only with payment of a fee. All transactions in the system may be handled by at least one payment server or facilitated by payment institutions like banks, credit card companies and Paypal.

The content receiver cum transmitter device 22 may be a media player 50 connectable to a network. Referring to FIG. 2, the media player 50 may include a display module 52 incorporated in the media player to show visual content. The display module 52 may be a screen such as, for example, TFT, OLED, LCD, or CSTN. The screen of the display module 52 may be touch-sensitive. There may be a camera module 54 incorporated in the media player 50 to record visual content. The camera module 54 should preferably have an imaging chip and firmware which are optimised for capturing moving images as the media player 50 may be used as a mobile broadcasting station. The media player 50 may also include an audio module 56 to input and output audio content. The audio module 56 may have a microphone to input audio content as per the media player's 50 use as a mobile broadcasting station. The audio module 56 may also have built-in speakers or a socket for headphones/earphones/speakers to enable the output of audio content. The media player 50 should include a memory module 57 for the storage of content in the media player 50. The stored content may be received and transmitted over a network using a wireless receiver cum transmitter module 58. The wireless receiver cum transmitter module 58 may utilise wireless technologies such as, for example, UWB, Bluetooth, infrared, or any form of radio frequency transmission. The aforementioned modules in the media player 50 may be controlled by a processor 60. As the media player 50 may be within a chaincast network, the receiver cum transmitter module 58 and the processor 60 may be continually operational even when the media player 50 is in a stand-by mode to receive and transmit data.

The media player 50 may be used like a media player similar to a Zen Vision from Creative Technology Ltd and may additionally be able to function like a mobile broadcaster cum receiver, where the user is able to use the media player 50 to make and receive recordings with moving images. Using the media player 50 in the system 20 enables the user to operate an independent broadcasting hub. Thus, the user may use the media player 50 to record a video diary, a filmlet, or even a movie. The system 20 allows for the transmission of large files without taking up too much bandwidth because of chaincast.

The media player 50 may have a graphical user interface shown on the screen of the display module 52 with a virtual “activator” (a predefined location on the screen) that may have different activation functions depending on content shown on the screen. For example, the virtual “activator” may be used to submit a bid price when the user is participating in an online auction. Alternatively, the virtual “activator” may also be used as a text message “send” button during a broadcast session, a voice transmit button (like a walkie-talkie) during a broadcast session, or may be used to invoke a transaction when the user is making a donation/making payment. The user's profile may be linked to a payment transmission/reception service to facilitate the conduct of commercial activities.

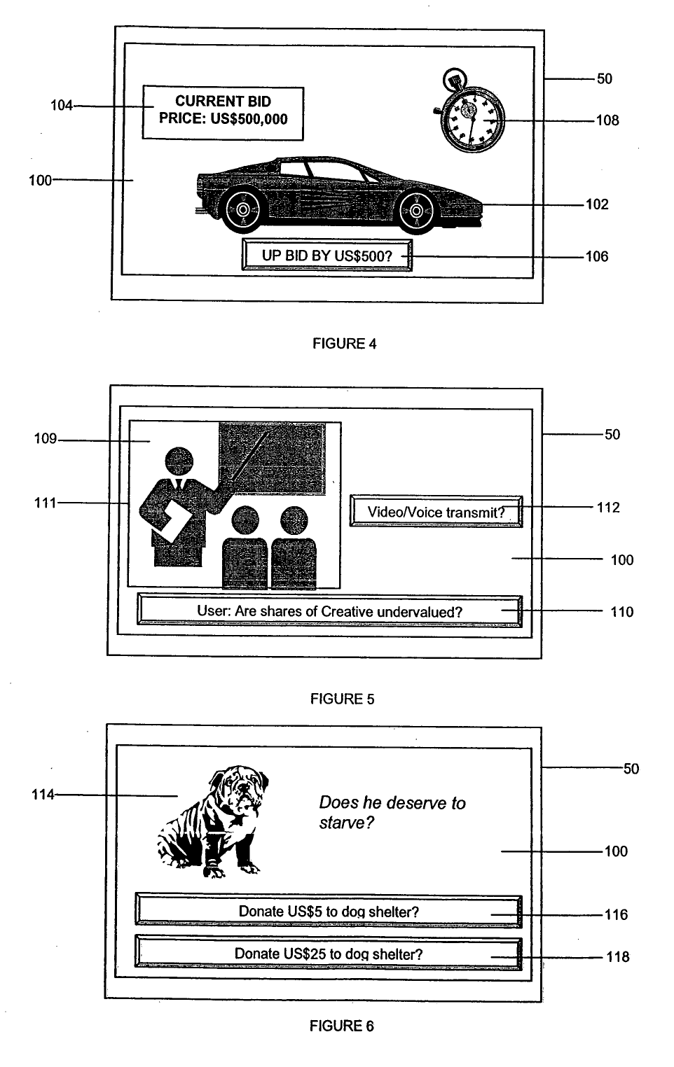

FIG. 4 shows the media player 50 when used in a sample auction. Not all features of the media player 50 are shown as they are unnecessary in aiding explanation for this aspect. A touch sensitive screen 100 shows an item 102 for auction. A current bid price 104 is denoted on the screen 100. The virtual “activator” 106 is shown providing the user an option to “increase the bid by US$500”. A time remaining for the auction is denoted by stopwatch 108. In this example, if the user touches the virtual “activator” 106 on the screen 100, a bid to increase the price of the item 102 by US$500 is submitted by the user, with the bid being tied in with the user's profile.

In another application of the media player 50 as shown in FIG. 5, there is shown the media player 50 being used for viewing a live broadcast of a presentation 109. The presentation 109 may be within it's own border 111 (as shown) or it may take up a viewing space of the entire screen 100. It should be noted that the presentation may be in an informal setting with a subject simply voicing an opinion on any particular subject akin to a video diary. During the live broadcast, the user may provide comments and/or ask questions either by voice transmission or text transmission (akin to SMS). In this regard, the screen 100 denotes two virtual “activators” 110, 112. In this example, the user may use a text input method available to the media player to input the question “Are shares of Creative undervalued?” before touching the virtual “activator” 110 on the screen 100 to send the question (in text form) to the subject giving the presentation. Alternatively, touching the virtual “activator” 112 on the screen 100 would enable the user to send the question “Are shares of Creative undervalued?” that the user asked either only verbally or in video form (with constant contact with the “virtual “activator” 112 being necessary when the question is being asked).

In a third application of the media player 50 as shown in FIG. 6, the example shows a depiction of an abandoned but otherwise healthy dog 114 at a dog shelter, an objective being to appeal for donations for the dog shelter. The user may receive such a screen if, for example, the users profile includes an interest towards pets. In this example, the screen 100 denotes two virtual “activators” 116, 118. Touching either “activator” 116, 118 would enable the dog shelter to receive donations of an amount depending on which “activator” 116, 118 was contacted by the user.

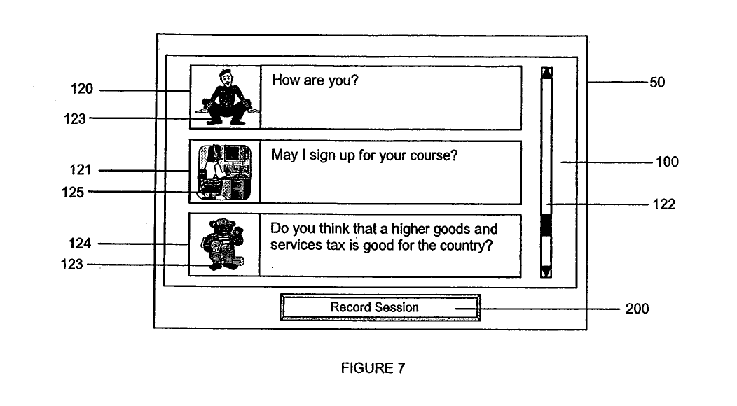

FIG. 7 depicts a fourth application of the media player 50. This application may be the media player 50 as used by a presenter of the presentation 109 as described in FIG. 5. As the presenter is making the presentation 109 using the media player 50, the presenter may receive “live” feedback, questions and/or comments that may or may not be in relation to the presentation 109. In this instance, there may be a scroll bar 122 to enable scrolling through all incoming feedback, questions and/or comments. The incoming feedback, questions and/or comments may be in text form (as shown in boxes 120/124 with avatar 123 identifying a specific sender) or in voice form (albeit converted to text using speech to text conversion software as shown in box 121 with an “operator” avatar 125 indicating an incoming voice input). In this example, the screen 100 denotes three virtual “activators” 120, 121 and 124. Touching either “activator” 120, 121 and 124 would enable the presenter to deal with all incoming feedback, questions and/or comments, by enabling replying, deleting, obtaining sender details and so forth. The presenter may also be able to store an entire interaction session by contacting a “record session” activator 200. This application may enable real time communication using the media player 50.

It is evident that the wider the screen of the display module, the greater the space available to display content and the less obstructive the virtual “activator” is to the user. In this regard, the virtual “activator” enables more channels of interactivity for the user when using the media player 50.

Regardless of whether the media player 50 is on the network, the processor may allow for the tracking of the advertisements being viewed/played back on the player 50. This information may be sent to the advertisement server 24 to to enable billing of the advertiser. This may be one way which the advertisers are charged. Alternatively, the advertisers may pay fees on a subscription basis which allows them to broadcast a predetermined number of advertisements over a predetermined period of time. The information for the tracking of the advertisements being viewed/played back on the player 50 may be either encrypted or DRM protected. This is to deter and minimise the incidence of tampering of the information which is of immense commercial value.

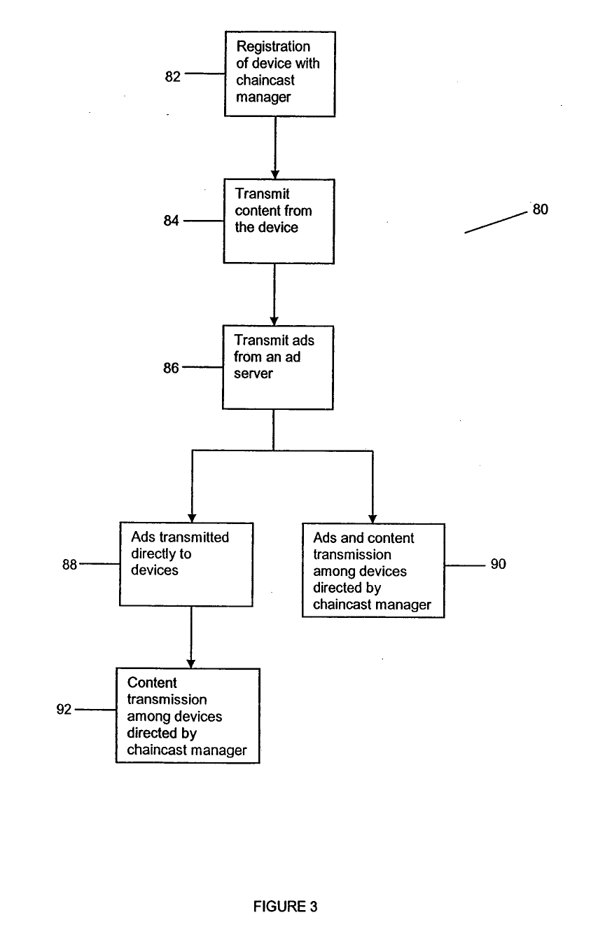

Referring to FIG. 3, there is also provided a flow chart for a method 80 of communicating content over a network. The method 80 includes registering a plurality of content receiver cum transmitter devices with a chaincast manager 82. If the plurality of content receiver cum transmitter devices are not registered with the chaincast manager, chaincasting will not be able to take place amongst the plurality of content receiver cum transmitter devices. After the plurality of content receiver cum transmitter devices are registered with the chaincast manager, content is transmitted from at least one of the content receiver cum transmitter devices 84. Whenever content is transmitted from at least one of the content receiver cum transmitter devices, an advertisement server would automatically transmit at least one advertisement 86. Content may be selectively stored on each content receiver cum transmitter device.

Advertisers may access the advertisement server to upload their advertisements with a plurality of settings, such as, for example, interest group, age group target, advertisement ratings and so forth. Access to the server by the advertisers may be made available for a fee. The advertisements may be tagged with related content (and subsequently transmitted together) or may be independent.

The advertisements may be directly transmitted to the other content receiver cum transmitter devices from the advertisement server 88. Content from the content receiver cum transmitter devices, and the advertisements on the content receiver cum transmitter devices may then be transmitted under the direction of the chaincast manager 92. Alternatively, the advertisements and content may also be directed to the plurality of content receiver cum transmitter devices by the chaincast manager 90. The advertisements may be of the interactive type.

In the aforementioned method, registering the plurality of content receiver cum transmitter devices with a chaincast manager may be done through a membership module. The chaincast manager may include a membership module that either allows or blocks access to the chaincast manager. The membership module may be part of the chaincast manager or an independent module which interacts with the chaincast manager. Access to the membership module may be allowed only with payment of a fee. The membership module may include storage of user parameters such as, for example, user interests, a right to broadcast content, a right to receive content, a right to participate in commercial activities, and channel favourites of the user. Generally, these parameters may be mandatory information required for the membership module to operate in a desired manner. The parameters stored in the membership module for a user enables the user to have a specific profile. Such a profile determines tasks which the user is able to perform. The profile also enables appropriate content/advertisements in accordance with the user's interests to be sent to the user should the user allow reception of the content/advertisements on their content receiver cum transmitter devices. The commercial activities allowable may include online auctions, online donations and online shopping. Users may be able to use their content receiver cum transmitter devices to bid for items in online auctions or make purchases from online stores/sellers. All transactions in the system may be handled by at least one payment server or facilitated by payment institutions like banks, credit card companies and Paypal.

Whilst there has been described in the foregoing description preferred embodiments of the present invention, it will be understood by those skilled in the technology concerned that many variations or modifications in details of design or construction may be made without departing from the present invention.

1. A communication system including:
a plurality of content receiver cum transmitter devices connected to a network, each device being for receiving content, for selectively storing content, and for selectively re-transmitting content;
at least one server for storage of advertisements and transmission of advertisements either directly to the plurality of content receiver cum transmitter devices, or the transmission of advertisements being directed by at least one chaincast manager, the at least one server for storage of advertisements and transmission of advertisements being either online or offline;
at least one content server connected to the network for storage of content and transmission of content either directly to the plurality of content receiver cum transmitter devices, or the transmission of content being directed by at least one chaincast manager; and
the at least one chaincast manager connected to the network for registering the plurality of content receiver cum transmitter devices, and for scheduling content and advertisement transfers amongst the plurality of content receiver cum transmitter devices.

2. The system of claim 1, further including a membership module for access to the chaincast manager.

3. The system of claim 2, wherein the membership module includes storage of user parameters, the user parameters selected from the group consisting of: profile score, user interests, a right to broadcast content using the system, a right to receive content using the system, a right to participate in commercial activities using the system, and channel favourites of the user.

4. The system of claim 2, wherein access to the membership module is either free or paid.

5. The system of claim 3, wherein the commercial activities are selected from the group consisting of: online auctions, online donations and online shopping.

6. The system of claim 1, wherein the content receiver cum transmitter device is a media player, the media player including:
a display module incorporated in the media player to show visual content;
a camera module incorporated in the media player to record visual content;
an audio module to input and output audio content;
at least one memory module to store content in the media player;
a wireless receiver cum transmitter module for input and output of content from the media player; and
a processor to control the aforementioned modules.

7. (canceled)

8. The system of claim 3, wherein scheduling the content and advertisement transfers by the chaincast manager is based on parameters selected from the group consisting of: profile score, broadcast requests sent from the plurality of content receiver cum transmitter devices, the user interests and the channel favourites of the user.

9. The system of claim 1, wherein the at least one server connected to the network for storage of advertisements is accessible by advertisers who upload their advertisements with a plurality of settings selected from the group consisting of: profile score, interest group, age group target and advertisement ratings.

10. The system of claim 1, wherein the content stored in the content server is transmitted either per a predetermined schedule or on an “on demand” basis.

11. (canceled)

12. (canceled)

13. The system of claim 1, wherein simultaneous recording and transmission of content by each content receiver cum transmitter device with minimal lag time is enabled.

14. The system of claim 1, wherein the advertisements are cached in the plurality of content receiver cum transmitter devices and transmitted at a later instance.

15. (canceled)

16. The system of claim 1, wherein at least one of the content servers includes a voice-to-text conversion function to convert voice-based content into a form which is text searchable.

17. The system of claim 1, wherein at least one of the content servers includes a voice identification function to enable voice-based content to be voice searchable.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. A method of communicating content over a network, including:
registering a plurality of content receiver cum transmitter devices with a chaincast manager;
transmitting content from the at least one content receiver cum transmitter device connected to a network;
selectively storing content from the at least one content receiver cum transmitter device;
selectively re-transmitting content from the at least one content receiver cum transmitter device;
transmitting advertisements from at least one advertisement server to either directly to a plurality of content receiver cum transmitter devices, or the transmission of advertisements being directed by at least one chaincast manager; and
receiving the content and advertisements on at least one content receiver cum transmitter device with the at least one chaincast manager scheduling content and advertisement transfers amongst the plurality of content receiver cum transmitter devices.

33. The method of claim 32, wherein registering the plurality of content receiver cum transmitter devices with a chaincast manager is done through a membership module.

34. The method of claim 33, wherein the membership module includes storage of user parameters, the user parameters selected from the group consisting of: profile score, user interests, a right to broadcast content, a right to receive content, a right to participate in commercial activities, and channel favourites of the user.

35. (canceled)

36. The method of claim 32, wherein the content receiver cum transmitter device is a media player connectable to a network, the media player including:
a display module incorporated in the media player to show visual content;
a camera module incorporated in the media player to record visual content;
an audio module to input and output audio content;
at least one memory module to store content in the media player;
a wireless receiver cum transmitter module for input and output of content from the media player; and
a processor to control the aforementioned modules.

37. (canceled)

38. The method of claim 34, wherein scheduling the content and advertisement transfers by the chaincast manager is based on parameters selected from the group consisting of: profile score, broadcast requests sent from the plurality of content receiver cum transmitter devices, the user interests and the channel favourites of the user.

39. The method of claim 32, wherein the at least one advertisement server is accessible by advertisers who upload their advertisements with a plurality of settings selected from the group consisting of: profile score, interest group, age group target and advertisement ratings.

40. (canceled)

41. (canceled)

42. The method of claim 32, wherein simultaneous recording and transmission of content by each content receiver cum transmitter device with minimal lag time is enabled.

43. (canceled)

44. (canceled)
